(19) United States
(12) Patent Application Publication
(10) Pub. No.: US 2025/0233781 A1
(43) Pub. Date: Jul. 17, 2025

(54) WIDE DYNAMIC RANGE CONTINUOUS-TIME LINEAR EQUALIZER (CTLE)

(71) Applicant: MACOM Technology Solutions Holdings, Inc., Lowell, MA (US)

(72) Inventors: Duy NGUYEN, Lowell, MA (US); Trong PHAN, Lowell, MA (US); Wayne KENNAN, Lowell, MA (US); Nguyen NGUYEN, Lowell, MA (US); Stefano D'AGOSTINO, Lowell, MA (US); William ALLEN, Lowell, MA (US)

(21) Appl. No.: 19/015,446

(22) Filed: Jan. 9, 2025

Related U.S. Application Data
(60) Provisional application No. 63/620,286, filed on Jan. 12, 2024.

(51) Int. Cl. H04L 25/03

(52) U.S. Cl. CPC H04L 25/03885; H04L 25/03343

(57) ABSTRACT

Systems, circuits, and methods for amplifying signals are provided. An illustrative circuit may include an amplifier that amplifies an input signal received at an input node of the amplifier and provides an amplified version of the input signal as an output signal at an output node of the amplifier. The circuit may further include at least one Continuous-Time Linear Equalizer (CTLE) circuit component connected with the amplifier, the CTLE circuit component providing an ultra-wide dynamic peaking control range for the amplifier.

### CROSS-REFERENCE TO RELATED APPLICATION

The present application claims the benefit of and priority, under 35 U.S.C. § 119, to U.S. Provisional Application Ser. No. 63/620,286, filed Jan. 12, 2024, entitled “WIDE DYNAMIC RANGE CONTINUOUS-TIME LINEAR EQUALIZER (CTLE)” the entire disclosure of which is hereby incorporated herein by reference, in its entirety, for all that it teaches and for all purposes.

### FIELD OF THE DISCLOSURE

The present disclosure is generally directed toward circuits and, in particular, toward amplifier circuits, driver circuits, and equalizer circuits.

### BACKGROUND

High speed data communication over a channel can lead to attenuation of high frequency components of the transmitted signals. Attenuation of the high frequency components may result in degraded signal quality and limit transmit speeds, leading to reduced bandwidth. To overcome this drawback, numerous data communication systems rely on equalizers to compensate for the unwanted effects of the channel. The equalizers have numerous coefficients (values or settings) which may be adjusted to optimally compensate for the effects of the channel on the signal.

Establishing the equalizer values is a complex task, and incorrectly selecting the coefficient values for the equalizer leads to sub-optimal equalization, which, as described above, reduces bandwidth and data transmit rates. In existing systems, the equalization was made easier by use of additional equalizers, such as use of a decision feedback equalizer (DFE) and/or a feed forward equalizer (FFE). The channel could be characterized from the DFE and FFE post-tap values and this information would be used to establish continuous-time linear equalizer (CTLE) coefficients. However, to gain the benefits of reduced size, cost, and power consumption, many communication systems avoid use of a DFE or FFE.

### SUMMARY

Current solutions can achieve a very limited CTLE dynamic range. Also, when controlling the CTLE, other specifications such as return loss, gain, bandwidth, and linearity are negatively impacted. Many applications, such as linear drive applications, demand a higher CTLE dynamic range to compensate for the different losses at different ports. Embodiments of the present disclosure aim to address these and other shortcomings of existing solutions. In particular, and in accordance with at least some embodiments of the present disclosure, improved peaking CTLE circuits and techniques are provided. According to at least some embodiments, the proposed CTLE circuits and techniques achieve a wide dynamic range with negligible negative impact on other performance specifications. Furthermore, various proposed CTLE circuits and techniques can be combined with other CTLE circuits and techniques to achieve and ultra-wide dynamic range (e.g., 20 dB or higher). Prior to the present solution(s), there were no amplifiers capable of achieving such a wide CTLE dynamic range.

While embodiments of the present disclosure are recognized as being useful for linear drive applications, it should be appreciated that the circuits and techniques depicted and described herein may also be useful in other applications. Thus, while embodiments of the present disclosure will be described in connection with linear applications for purposes of explanation, it should be appreciated that embodiments of the present disclosure are not so limited.

In some embodiments, a circuit, such as an amplifier circuit, is provided that includes: an amplifier that amplifies an input signal received at an input node of the amplifier and provides an amplified version of the input signal as an output signal at an output node of the amplifier; and at least one Continuous-Time Linear Equalizer (CTLE) circuit component connected with the amplifier, where the CTLE circuit component provides an ultra-wide dynamic peaking control range for the amplifier.

In some embodiments, a system is provided that includes: a receiver circuit connected between a communication channel and a deserializer, where the receiver circuit includes: an amplifier; and at least one Continuous-Time Linear Equalizer (CTLE) circuit component connected with the amplifier, where the CTLE circuit component provides an ultra-wide dynamic peaking control range for the amplifier.

In some embodiments, a method is provided that includes: determining one or more operating constraints for a receiver circuit, wherein the receiver circuit comprises an amplifier; determining a desired Continuous-Time Linear Equalizer (CTLE) controlled range for the receiver circuit; selecting one or more CTLE circuit components to achieve the desired CTLE controlled range while complying with the one or more operating constraints; connecting the one or more CTLE circuit components to the amplifier; and processing a data signal at the receiver circuit with the one or more CTLE circuit components connected to the amplifier, where the one or more CTLE circuit components provides an ultra-wide dynamic peaking control range for the amplifier.

The preceding is a simplified summary to provide a basic understanding of some aspects and embodiments described herein. This summary is not an extensive overview of the disclosed subject matter. It is neither intended to identify key nor critical elements of the disclosure nor delineate the scope thereof. The summary is provided to present some concepts in a simplified form as a prelude to the more detailed description that is presented later.

### BRIEF DESCRIPTION OF THE DRAWINGS

The present disclosure is described in conjunction with the appended figures, which are not necessarily drawn to scale:

FIG. 1 is a block diagram illustrating a communication system according to at least some embodiments of the present disclosure;

FIG. 2 is a block diagram illustrating an amplifier circuit that may be provided as part of transmitter circuit or receiver circuit according to at least some embodiments of the present disclosure;

FIG. 3 illustrates details of one stage of the driver or TIA according to at least some embodiments of the present disclosure;

FIG. 4 illustrates details of another stage of the driver or TIA according to at least some embodiments of the present disclosure;

FIG. 5 illustrates different CTLE setting voltage gain/frequency response curves for the second receiver component according to at least some embodiments of the present disclosure;

FIG. 6 illustrates details of a third circuit component according to at least some embodiments of the present disclosure;

FIG. 7 illustrates details of another circuit component that may be used;

FIG. 8 illustrates details of a first example of a fourth circuit component according to at least some embodiments of the present disclosure;

FIG. 9 illustrates details of a second example of a fourth circuit component according to at least some embodiments of the present disclosure;

FIG. 10 illustrates details of a fifth circuit component according to at least some embodiments of the present disclosure;

FIG. 11 illustrates differential mode gain for different control voltages applied to the fifth circuit component according to at least some embodiments of the present disclosure; and

FIG. 12 illustrates a method of configuring and operating an amplifier circuit according to at least some embodiments of the present disclosure.

### DETAILED DESCRIPTION

It is with respect to the above-noted challenges that embodiments of the present disclosure were contemplated. In particular, a system, circuits, and method of operating such circuits are provided that solve the drawbacks associated with existing amplifier circuits, driver circuits, and/or equalizer circuits.

While embodiments of the present disclosure will primarily be described in connection with amplifier circuits used in high-bandwidth applications, it should be appreciated that embodiments of the present disclosure are not so limited. Furthermore, while embodiments of the present disclosure are contemplated for use in connection with linear drive applications, driver amplifiers and transimpedance amplifiers (TIAs) using bipolar junction transistors (BJTs) or field-effect transistors (FETs), and the like, it should be appreciated that embodiments of the present disclosure are not so limited.

Various aspects of the present disclosure will be described herein with reference to drawings that are schematic illustrations of idealized configurations. It should be appreciated that while particular circuit configurations and circuit elements are described herein, embodiments of the present disclosure are not limited to the illustrative circuit configurations and/or circuit elements depicted and described herein. Specifically, it should be appreciated that circuit elements of a particular type or function may be replaced with one or multiple other circuit elements to achieve a similar function without departing from the scope of the present disclosure.

It should also be appreciated that the embodiments described herein may be implemented in any number of form factors. Specifically, the entirety of the circuits disclosed herein may be implemented in silicon as a fully-integrated solution (e.g., as a single Integrated Circuit (IC) chip or multiple IC chips) or they may be implemented as discrete components connected to a Printed Circuit Board (PCB).

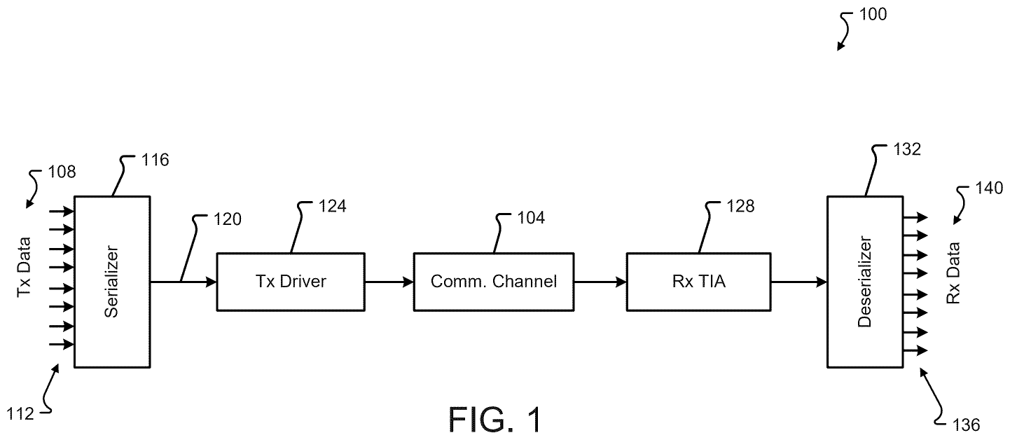

Referring initially to FIG. 1, an illustrative communication system 100 will be described in accordance with at least some embodiments of the present disclosure. The system 100 represents but one possible environment of use of the innovation(s) disclosed herein. As shown, data to be transmitted, referred to as transmit data 108 is provided over two or more parallel paths 112 to a serializer 116. The serializer 116 converts the data received from the two or more parallel paths 112 to a serial stream of data on serial data path 120. The serial stream of data is presented to a transmission driver 124 which amplifies the signal to a level suitable for transmission over a communication channel 104.

The communication channel 104 may include or correspond to any suitable type of communication channel, such as a channel used for high speed data transmission. The communication channel 104 may correspond to or include one or more optical fibers. The communication channel 104 may alternatively or additionally correspond to or include one or more electrically-conductive lines. Thus, the data transmitted by the transmission driver 124 may include an optical signal and/or electrical signal. In one embodiment, the communication channel 104 is a very short reach channel, which may only be several centimeters of PCB trace long. However, the method and apparatus disclosed herein may be used for channels of any length or type, such as but not limited to, fiber channels, circuit board traces, or wired channels, all of which may be any suitable length.

After passing through the communication channel 104, the data is presented to a receiver circuit 128. The receiver circuit 128 may include one or more TIAs. The transmitter circuit 124 may include one or more drivers. The transmitter circuit 124 and/or receiver circuit 128 may be provided with one or more amplifier circuits comprising one or more equalizer circuits, which may include a CTLE circuit. The equalizer(s) may be configured to reduce the signal attenuating effects of the communication channel 104.

After equalization, the data is provided to a deserializer 132 which converts the serial data stream to a parallel data path on the two or more data paths 136. The data output by the deserializer may be regarded as received data 140 that can be processed by a communication device that includes the receiver circuit 128 and deserializer 132.

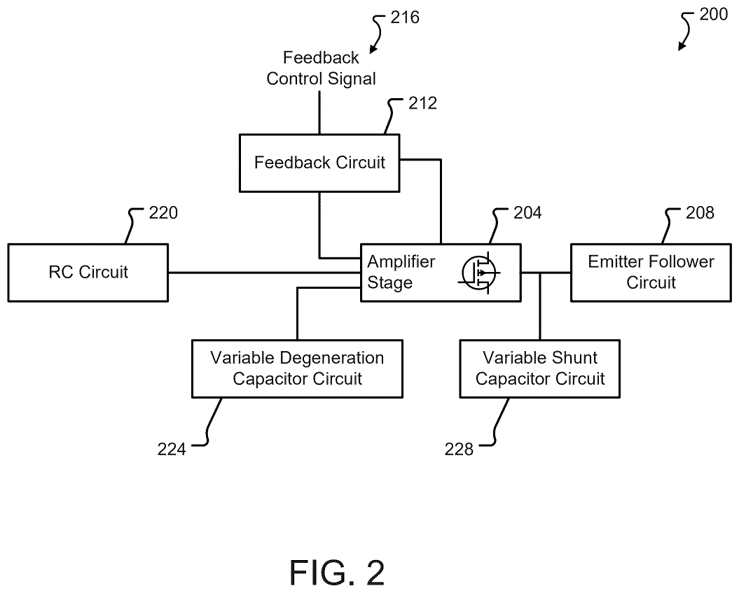

Referring now to FIG. 2, additional details of an amplifier circuit 200 will be described in accordance with at least some embodiments of the present disclosure. The amplifier circuit 200 may be provided as part of the transmitter circuit 124 and/or receiver circuit 128. The amplifier circuit 200 is shown to include a number of different circuit components that support equalization functions for the amplifier stage 204. Illustrative but non-limiting examples of circuit components that may be provided in the amplifier circuit 200 and may be connected, either directly or indirectly, to the amplifier stage 204 include an emitter follower circuit 208, a feedback circuit 212 that is adjusted with a feedback control signal 216, an RC circuit 220, a variable degeneration capacitor circuit 224, and a variable shunt capacitor circuit 228. As will be described in further detail herein, one, some, or all of the circuit components may be provided in the amplifier circuit 200 to provide CTLE and achieve ultra-wide dynamic peaking control. In some embodiments, various combinations of the circuit components may be able to provide the amplifier circuit 200 with the ability to accommodate different specifications and dynamic CTLE ranges (e.g., the CTLE controlled range could be anywhere from 2 dB to larger than 15 dB at a peaking frequency greater than 10 GHz).

While FIG. 2 illustrates the amplifier circuit 200 as having five different circuit components connected with the amplifier stage 204, it should be appreciated that the amplifier circuit 200 may include one, two, three, four, or all five of the components illustrated in FIG. 2. Specifically, but without limitation, the amplifier circuit 200 may include any one of the circuit components (e.g., just the emitter follower circuit 208, just the feedback circuit 212, just the RC circuit 220, just the variable degeneration capacitor circuit 224, or just the variable shunt capacitor circuit 228). Alternatively or additionally, the amplifier circuit 200 may include any combination of two circuit components, any combination of three circuit components, or any combination of four circuit components without departing from the scope of the present disclosure. Some of the circuit components may be connected to an input of the amplifier stage 204 whereas other circuit components may be connected to an output of the amplifier stage 204. In some embodiments (e.g., with the feedback circuit 212), the circuit component may be connected across two terminals of the amplifier stage 204. It should be appreciated that a combination of circuit components may be selected based on the advantages and disadvantages provided by each circuit component. The selection of circuit components may depend upon amplifier specifications and/or required CTLE ranges.

Multiple CTLE techniques or circuit components can co-exist on the same transmitter or receiver circuit 124, 128 and support equalization for the amplifier stage 204. Separate digital control signals (or registers) can be assigned to each circuit component. In some embodiments, a user can use digital control to enable/disable and control each circuit component independently. Depending on operational requirements and specifications defined for the amplifier circuit 200, the combination of different CTLE components or techniques can be chosen to achieve the required peaking dynamic range while satisfying other specifications, which may include one or more of: gain, bandwidth, return loss, linearity, and power consumption. It should also be appreciated that a single amplifier stage 204 may have multiple CTLE circuit components connected thereto, with various combinations of CTLE circuit components being used for different applications. Providing an amplifier stage 204 with multiple CTLE circuit components that can be enabled/disabled on demand helps to eliminate the need for different design variants or versions.

In some embodiments, the amplifier stage 204 may correspond to or include a transistor or multiple transistors. As a non-limiting example, the amplifier stage 204 may include a bipolar junction transistor (BJT) having a base, collector, and emitter. Other types of amplification devices may also be provided in the amplifier stage 204. For instance, the amplifier stage 204 may include any type of metal oxide semiconductor field-effect transistor (MOSFET) device.

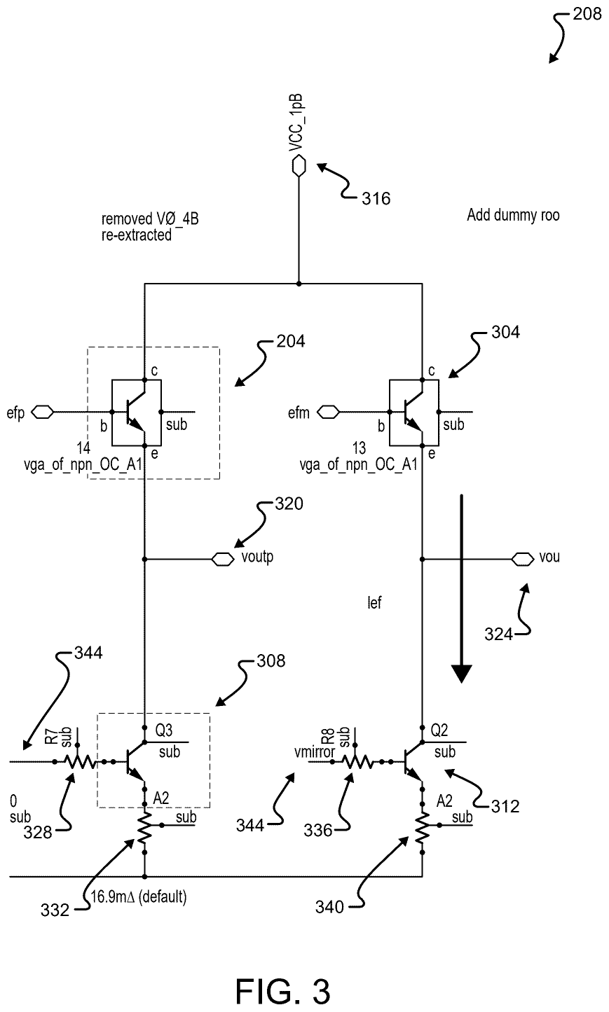

Referring now to FIGS. 3 thru 11, additional details of the various CTLE circuit components that may be provided in an amplifier circuit 200 and that may facilitate CTLE techniques across a dynamic range higher than 15 dB will be described in accordance with at least some embodiments of the present disclosure.

Referring initially to FIG. 3, additional details of an emitter follower circuit 208 will be described. The emitter follower circuit 208 may be connected to an output of the amplifier 204. Specifically, but without limitation, the emitter follower circuit 208 may be connected to one or more outputs of the amplifier 204 (e.g., connected to an emitter and/or collector terminal of the amplifier 204).

In some embodiments, the emitter follower circuit 208 is provided to control the DC current in the emitter follower stage. Controlling the DC current (e.g., the emitter-follower current Ief) in this way can help to control CTLE. On a positive side, the emitter follower circuit 208 is relatively easy to implement and no significant amount of additional layout is required. When the emitter follower circuit 208 is the only CTLE circuit component provided as part of the receiver circuit 128, there may be non-trivial signal degradation at a low CTLE setting for large signals.

The emitter follower circuit 208 may be provided with a first transistor 304, a second transistor 308, and third transistor 312. The transistors 304, 308, 312 may be connected in a parallel network across the output(s) of the amplifier 204. The emitter follower circuit 208 may also include a bias voltage input 316 and a control voltage Vctrl 344, where a control voltage Vctrl 344 is provided to selectively activate, deactivate, or otherwise control the emitter-follower current Ief. The emitter follower circuit 208 may also include a supply voltage Vcc 316.

The emitter follower circuit 208 is also shown to include a plurality of resistors 328, 332, 336, and 340. The first transistor 304 is not illustrated to have a resistor connected to its base or emitter. The second transistor 308 and third transistor 312 are illustrated to have a resistor connected to the base and a resistor connected to the emitter. The emitter follower circuit 208 is also shown to include differential outputs 320, 324. One output terminal 320 is provided between the emitter of the amplifier 204 and the collector of the second transistor 308. The other output terminal 324 is provided between the emitter of the first transistor 304 and the collector of the third transistor 312.

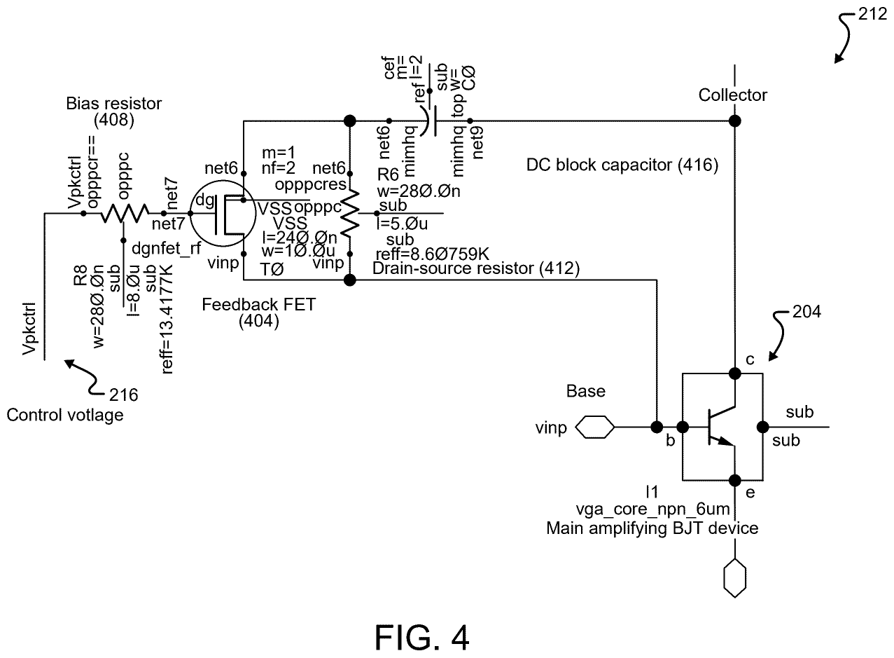

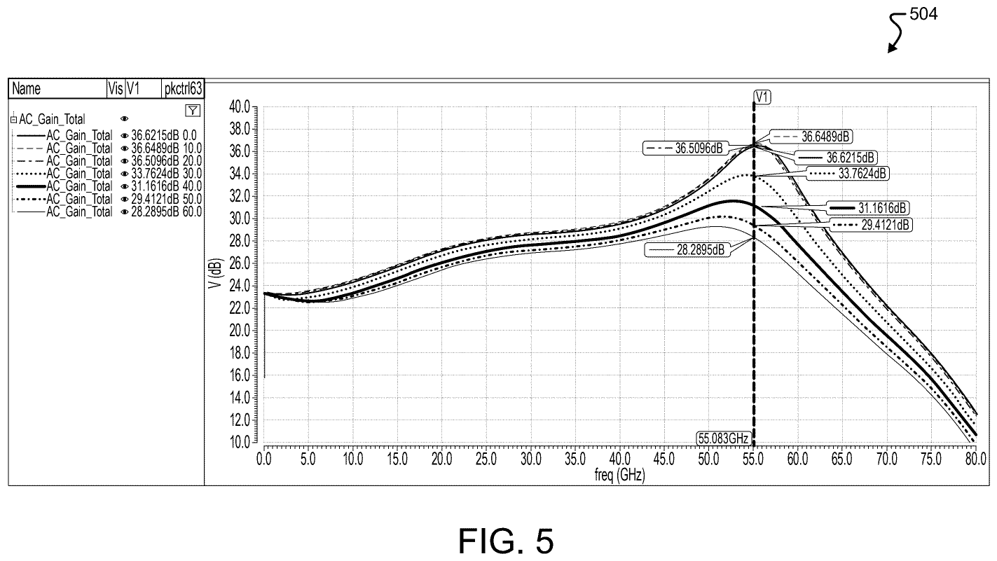

Referring now to FIGS. 4 and 5, additional details of a feedback circuit 212 will be described in accordance with at least some embodiments of the present disclosure. The CTLE technique provided by the feedback circuit 212 incorporates a feedback network between the collector and the base of the amplifier 204 in one variable gain amplifier (VGA) stage. The feedback circuit 212 can be applied for any or all stages in the amplifier. The feedback circuit 212 can also be applied to a FET device in which the feedback network is connected between the drain and gate of the FET.

Illustratively, but without limitation, the feedback circuit 212 includes a low parasitics FET 404 with a control voltage 216 and bias resistor 408 at the gate of the FET 404. The feedback circuit 212 is also shown to include a resistor 412 between the drain and source to keep the FET 404 in a linear region, and a capacitor 416 to block DC voltage.

In some embodiments, the CTLE (peaking) level can be controlled by setting the control voltage 216 at the gate (Vctrl). When Vctrl=0V, the FET 404 is turned off and the feedback network is virtually open, thereby resulting in a maximum peaking state. Conversely, when the control voltage 216 at the gate (Vctrl) is increased, the FET 404 is slowly turned on and will act as a variable resistor. This feedback network will reduce the peaking of the amplifier 204. With the full control range, the CTLE dynamic range can be between approximately 6 dB to 10 dB, depending on the FET 404 device size. Over the entire CTLE control range, the gain, bandwidth, and large signal linearity are not significantly impacted.

As can be seen in FIG. 5, which illustrates a number of frequency response curves 504 at different CTLE settings, the full CTLE range is approximately 8.5 dB at a peaking frequency of 55 GHz. This improved CTLE range is achieved without a significant impact to the amplifier 204 gain at 1 GHz. Additionally, the CTLE range is improved while minimally impacting input return loss, group delay, large signal characteristics, and linearity (e.g., THD, gain, and compression).

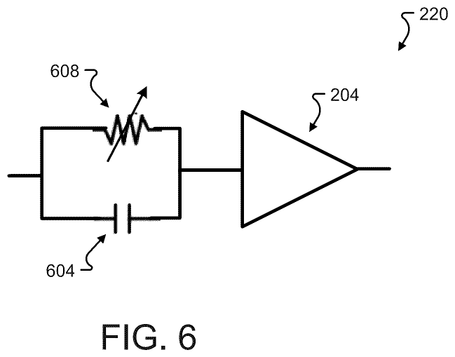

Referring now to FIG. 6, additional details of an RC circuit 220 used to provide CTLE functionality will be described in accordance with at least some embodiments of the present disclosure. The RC circuit 220 is shown to include an amplifier 204 having a capacitor 604 and a variable resistor 608 connected in parallel at the input of the amplifier 204. The variable resistor 608 may correspond to any suitable type of variable resistor device and may be controlled by a control voltage (e.g., a linear FET device).

Advantageously, the RC circuit 220 is relatively easy to implement and provides a wide dynamic range. Other implications that may need to be considered when utilizing the RC circuit 220 is that the RC circuit 220 may reduce the overall gain of the amplifier 204 and possible impact on the input return loss. For instance, the amplifier 204 may have different return losses at different CTLE settings.

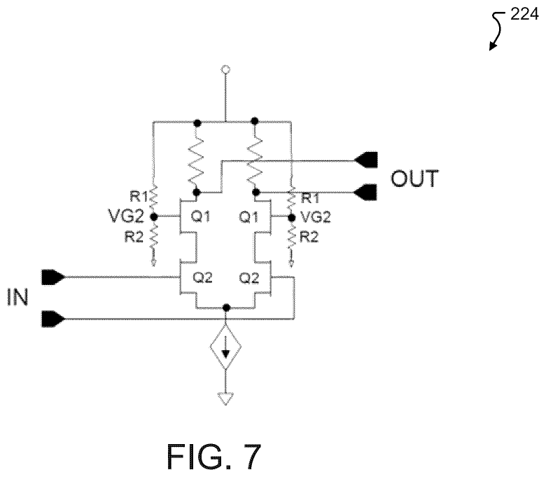

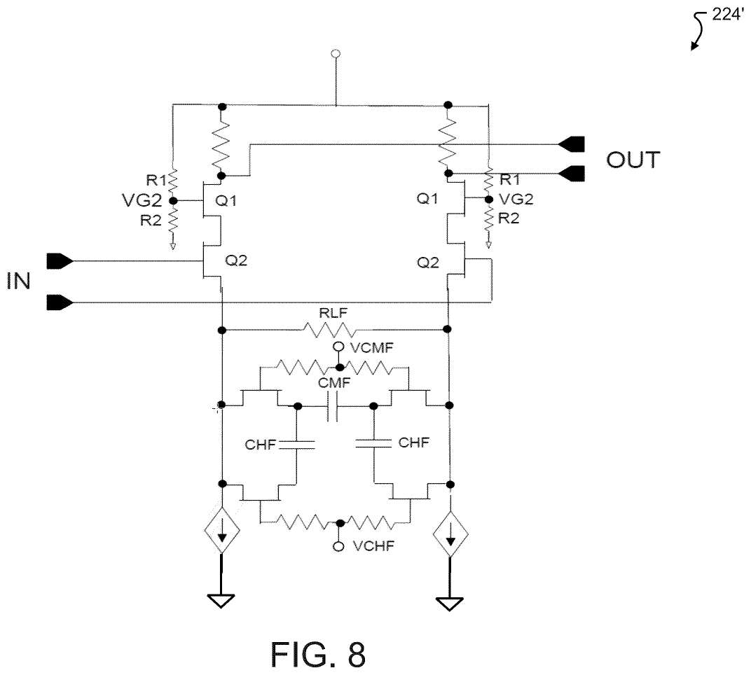

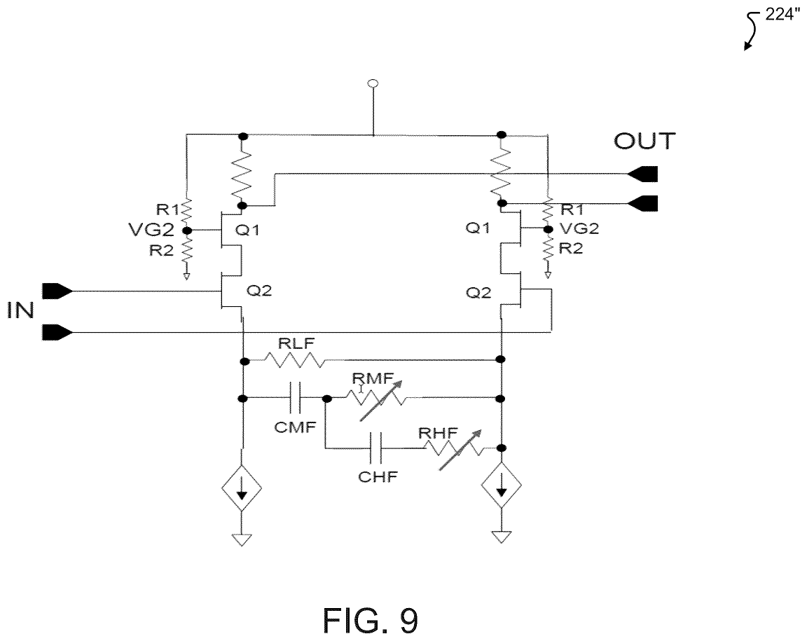

Referring now to FIGS. 7-9, various examples of circuits 224, 224′, 224″ will be described in accordance with at least some embodiments of the present disclosure. FIG. 7 illustrates a simple circuit that doesn't provide a variable degeneration capacitor whereas FIGS. 8 and 9 illustrate examples of circuits 224′, 224″ that do provide a variable degeneration capacitor to the amplifier circuit 200. A variable degeneration capacitor circuit 224′, 224″ may be used to add a variable degeneration capacitor to the amplifier circuit 200. On a positive side, the variable degeneration capacitor circuit 224′, 224″ may have little to no impact on DC gain. Indeed, several degeneration capacitors can be added to provide multiple peaking frequencies.

Circuit 224 of FIG. 3 illustrates a conventional differential cascode circuit with no degeneration. The top transistors Q1 are common gate transistors connected to the bottom common source transistors Q2. This cascode connection of transistors is often used to achieve higher gain and bandwidth than a simple differential common source amplifier with only the Q2 transistors.

The first example and second example of the variable degeneration capacitor circuit 224′, 224″ add variable degeneration capacitors, CMF and CHF, to create different frequency tuning effects at a middle frequency with CMF and a high frequency with CHF. The second example of the variable degeneration capacitor circuit 224″ provides an idealized configuration of a low frequency resistor RLF, a middle frequency resistor RMF, and a high frequency resistor RHF to degenerate the bottom common source transistors Q2. The middle frequency resistor RMF and high frequency resistor RHF are shown as variable resistors, each having a resistance that is capable of being tuned. In an ideal configuration, the resistance provided by each resistor RMF, RHF may be adjusted from a value of approximately zero to a value suitable to tune the circuit within a middle frequency range and a high frequency range.

The middle frequency resistor RMF is also shown to be connected in series with a middle frequency capacitor CMF. The high frequency resistor RHF if shown to be connected in series with a high frequency capacitor CHF. Adjustment of the variable resistors RMF, RHF cause the capacitors CMF, CHF to be effectively turned on and off, thereby selectively bringing the capacitors into operation between the common source transistors Q2.

The first example of the variable degeneration capacitor circuit 224′ illustrates a non- idealized representation of the variable degeneration capacitor circuit 224″. In the illustration of FIG. 8, the variable resistors RMF, RHF are implemented as FETs to provide variable, (e.g., tunable), resistance and provide a desired turning for the variable degeneration capacitor circuit 224″.

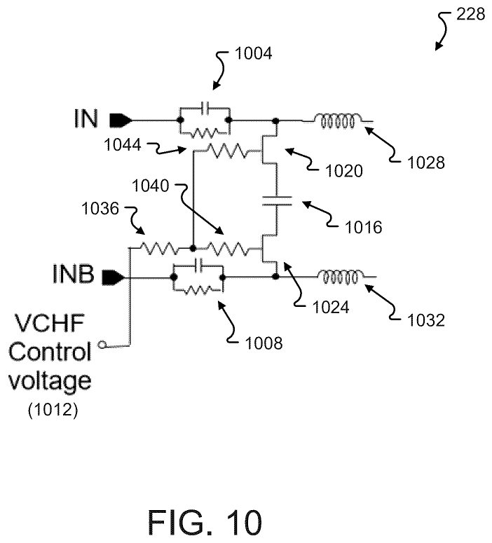

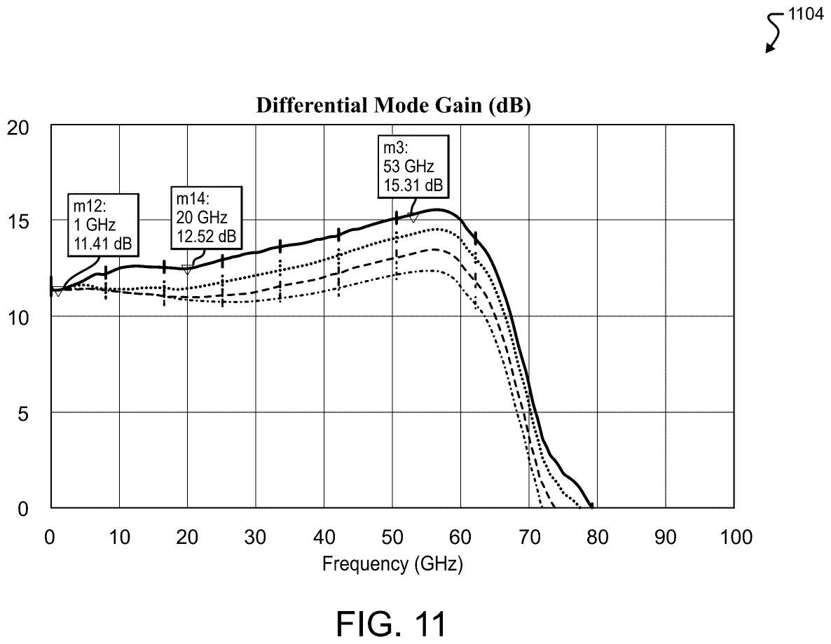

Referring now to FIGS. 10 and 11, additional details of a variable shunt capacitor circuit 228 will be described in accordance with at least some embodiments of the present disclosure. The variable shunt capacitor circuit 228 is shown to include a differential input IN, INB feeding a differential output across parallel inductors 1028, 1032. The variable shunt capacitor circuit 228 may be controlled by a VCHF control voltage 1012, which tunes a value of a shunt capacitor 1016 connected between the inductors 1028, 1032.

The variable shunt capacitor circuit 228 is also shown to include a first RC pair 1004 connected to one side of the differential input IN and second RC pair 1008 connected to another side of the differential input INB. The shunt capacitor 1016 is connected between the RC pairs 1004, 1008 and the inductors 1028, 1032. An amount of capacitance provided by the variable capacitor 1016 may be adjusted by changing the VCHF control voltage 1012, which is connected to a pair of transistors 1020, 1024, between which the fixed capacitor 1016 is provided. The VCHF control voltage 1012 may be connected to the transistors 1020, 1024 through a network of resistors 1036, 1040, 1044, whose resistance values are selected to be high enough to bias the FETs 1020 and 1024 without any adverse effects on performance of the amplifier circuit 200.

The two transistors 1020, 1024 act as variable resistors to switch in the capacitor 1016 between them. When the transistors 1020, 1024 are biased off, they will be nearly open circuits and the capacitor 1016 will not be connected. When the transistors 1020, 1024 are turned on, they will connect the capacitor 1016 to the differential ports and attenuate the input signal as a function of frequency. Low frequencies will be attenuated less than high frequencies so it can be used as a gain peaking control. The size of the transistors 1020, 1024 determines the minimum resistance which, in turn, determines the dynamic range of this circuit 228. As the VCHF control voltage 1012 is changed between maximum (full on) and minimum (full off), the frequency response 1104 varies as shown in FIG. 11.

In some embodiments, the variable capacitor 1016 can be placed at an input of the emitter follower circuit 208. It should be appreciated that the variable shunt capacitor circuit 228 can be placed at an input of any amplifier circuit or stage. As mentioned above and as depicted, the variable shunt capacitor circuit 228 may be implemented between two differential ports. In this latter case, grounding is not necessary because there is a virtual ground at the point of symmetry.

It should be appreciated that any combination of CTLE circuit components 208, 212, 220, 224, 228 may be implemented in a transmitter circuit 124 and/or a receiver circuit 128 without departing from the scope of the present disclosure. As an example, a combination of two, three, four, or five CTLE circuit components 208, 212, 220, 224, 228 may be implemented on a distributed amplifier. As a further non-limiting example, the amplifier circuit 200 may be implemented on a differential Gallium Arsenide distributed amplifier.

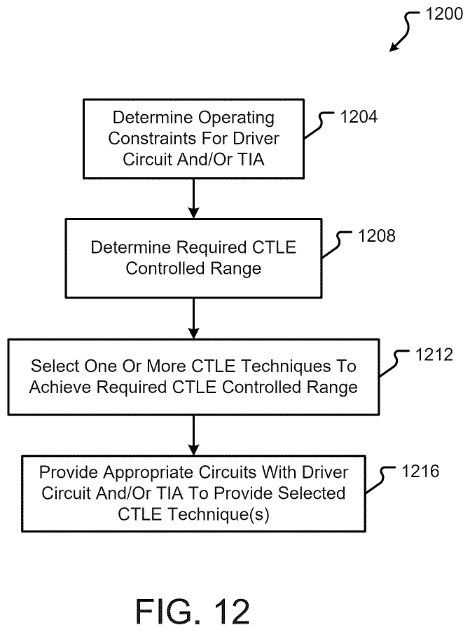

Referring now to FIG. 12, a method 1200 of configuring and operating an amplifier circuit 200, which may be provided as part of a transmitter circuit 124 and/or as part of a receiver circuit 128, will be described in accordance with at least some embodiments of the present disclosure. The method 1200 begins by determining one or more operating constraints for the circuit 200 (step 1204). It should be appreciated that the operating constraints may include constraints for the circuit 200, a driver circuit therefor, an amplifier 204 in the circuit, or the like. In some embodiments, the operating constraints may include one or more of gain, bandwidth, input return loss, group delay, large signal characteristics, and linearity (e.g., THD, gain, and compression).

The method 1200 may continue by determining a required CTLE controlled range (step 1208). This step may include determining a desired peaking frequency for the circuit 200. This step may also include determining a desired frequency response at a particular voltage gain.

The method continues by selecting one or more CTLE techniques to achieve the desired CTLE controlled range while complying with the operating constraints (step 1212). Appropriate CTLE circuit components may then be selected to based on the CTLE technique(s) selected in step 1212 (step 1216). In some embodiments, CTLE circuit components that may be selected and provided as part of a driver circuit and/or TIA may include one or more of an emitter follower circuit 208, a feedback circuit 212, an RC circuit 220, a variable degeneration capacitor circuit 224, and a variable shunt capacitor circuit 228.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A circuit, comprising:
an amplifier that amplifies an input signal received at an input node of the amplifier and provides an amplified version of the input signal as an output signal at an output node of the amplifier; and
at least one Continuous-Time Linear Equalizer (CTLE) circuit component connected with the amplifier, wherein the CTLE circuit component provides an ultra-wide dynamic peaking control range for the amplifier.

2. The circuit of claim 1, wherein the ultra-wide dynamic peaking control range for the amplifier is greater than 2 dB at a peaking frequency greater than 10 GHz.

3. The circuit of claim 1, wherein the at least one CTLE circuit component comprises two or more CTLE circuit components selected from the following: an emitter follower circuit, a feedback circuit, a resistor-capacitor (RC) circuit, a variable degeneration capacitor circuit, and a variable shunt capacitor circuit.

4. The circuit of claim 1, wherein the at least one CTLE circuit component comprises three or more CTLE circuit components selected from the following: an emitter follower circuit, a feedback circuit, a resistor-capacitor (RC) circuit, a variable degeneration capacitor circuit, and a variable shunt capacitor circuit.

5. The circuit of claim 1, wherein the at least one CTLE circuit component comprises four or more CTLE circuit components selected from the following: an emitter follower circuit, a feedback circuit, a resistor-capacitor (RC) circuit, a variable degeneration capacitor circuit, and a variable shunt capacitor circuit.

6. The circuit of claim 1, wherein the at least one CTLE circuit component comprises: an emitter follower circuit, a feedback circuit, a resistor-capacitor (RC) circuit, a variable degeneration capacitor circuit, and a variable shunt capacitor circuit.

7. The circuit of claim 1, wherein the at least one CTLE circuit component comprises a feedback circuit connected between an input and an output of the amplifier.

8. The circuit of claim 7, wherein the amplifier comprises a transistor having a base, a collector, and an emitter, wherein the feedback circuit is connected between the collector and the base, and wherein the feedback circuit comprises at least one transistor with a controlled voltage and a bias resistor connected to a gate of the at least one transistor that operates in a linear region.

9. The circuit of claim 8, wherein the feedback circuit further comprises a capacitor to isolate the DC bias voltage of the base and the collector of the transistor.

10. The circuit of claim 8, wherein the controlled voltage is increased to turn on the transistor and to reduce a peaking of the amplifier.

11. The circuit of claim 1, wherein the amplifier comprises a differential amplifier and wherein the at least one CTLE circuit component comprises a variable degeneration capacitor circuit that adds a variable degeneration capacitor to the amplifier.

12. The circuit of claim 12, wherein the at least one CTLE circuit comprises a plurality of variable resistors to switch in one or more capacitors as part of adjusting a capacitance provided by the variable degeneration capacitor circuit.

13. The circuit of claim 1, wherein the amplifier comprises a differential amplifier and wherein the at least one CTLE circuit component comprises a variable shunt capacitor connected at an emitter of the differential amplifier.

14. The circuit of claim 13, wherein the at least one CTLE circuit component further comprises an emitter follower circuit and wherein the variable shunt capacitor is connected at an input of the emitter follower circuit.

15. A system, comprising:
a receiver circuit connected between a communication channel and a deserializer, wherein the receiver circuit comprises:
an amplifier; and
at least one Continuous-Time Linear Equalizer (CTLE) circuit component connected with the amplifier, wherein the CTLE circuit component provides an ultra-wide dynamic peaking control range for the amplifier.

16. The system of claim 15, wherein the amplifier comprises a differential amplifier.

17. The system of claim 15, wherein the amplifier comprises a Bipolar Junction Transistor (BJT) or Field-Effect Transistor (FET).

18. The system of claim 15, wherein the at least one CTLE circuit component comprises a plurality of circuit components selected from the following: an emitter follower circuit, a feedback circuit, a resistor-capacitor (RC) circuit, a variable degeneration capacitor circuit, and a variable shunt capacitor circuit.

19. The system of claim 15, wherein the ultra-wide dynamic peaking control range for the amplifier is greater than 2 dB at a peaking frequency greater than 10 GHz.

20. A method, comprising:
determining one or more operating constraints for a receiver circuit, wherein the receiver circuit comprises an amplifier;
determining a desired Continuous-Time Linear Equalizer (CTLE) controlled range for the receiver circuit;
selecting one or more CTLE circuit components to achieve the desired CTLE controlled range while complying with the one or more operating constraints;
connecting the one or more CTLE circuit components to the amplifier; and
processing a data signal at the receiver circuit with the one or more CTLE circuit components connected to the amplifier, wherein the one or more CTLE circuit components provides an ultra-wide dynamic peaking control range for the amplifier.
